(19) United States
(12) Patent Application Publication
(10) Pub. No.: US 2026/0105511 A1
(43) Pub. Date: Apr. 16, 2026

(54) Business Processes in Antibody-Drug Conjugate (ADC) Development, Manufacturing, Financing, & Patient Access

(71) Applicant: Arya Bhushan, Nashua, NH (US)

(72) Inventor: Arya Bhushan, Nashua, NH (US)

(21) Appl. No.: 19/363,162

(22) Filed: Oct. 20, 2025

(51) Int. Cl. G06Q 30/08; G06Q 10/0635; G06Q 50/04

(52) U.S. Cl. CPC G06Q 30/08; G06Q 10/0635; G06Q 50/04; G06Q 2220/00

(57) ABSTRACT

Computer-implemented systems, methods, and non-transitory computer-readable media for improving the economics and business processes of antibody-drug conjugates (ADCs). Embodiments include: a Dynamic Manufacturing Capacity Exchange that allocates scarce contract manufacturing slots via risk-adjusted auctions, an Outcome-Indexed Royalty Securitization Platform that structures milestone and royalty securities with coupon payments dynamically tied to clinical outcomes, an Adaptive Licensing Contract Generator that automatically restructures licensing ladders and escrows based on dossier completeness, a Supply Chain Risk Hedger that integrates IoT shipment monitoring with smart contract-based payouts and rebooking, and a Patient Affordability Clearinghouse that optimizes affordability pathways using program eligibility rules and computational solvers.

### CROSS-REFERENCE TO RELATED APPLICATIONS

None.

### FIELD OF THE INVENTION

The present invention relates to biotechnology business systems. More specifically, it relates to computer-implemented methods, apparatus, and non-transitory storage media that improve the economics of antibody-drug conjugates (ADCs), a rapidly expanding class of oncology therapeutics.

### BACKGROUND OF THE INVENTION

### ADC Market Context

Antibody-drug conjugates (ADCs) represent a fusion of monoclonal antibodies with cytotoxic payloads via linker chemistry. They offer targeted tumor cell killing while sparing normal tissues.

As of 2024, more than a dozen ADCs had received regulatory approval, with hundreds in clinical pipelines. The market for ADCs was valued in excess of USD 10 billion and projected to grow at double-digit CAGR.

Despite this promise, the economic infrastructure of ADC innovation remains fragile. The average development cost exceeds USD 1 billion, with clinical attrition rates of 80-90%.

Many biotech firms developing ADCs lack in-house manufacturing and rely on contract manufacturing organizations (CMOs), leading to intense slot competition.

Capacity bottlenecks cause companies to pay premiums or rebook slots, sometimes losing tens of millions per failed booking.

Conventional manufacturing agreements are rigid, lacking mechanisms to adjust dynamically when risk or dossier status changes.

### Financing and Investment Limitations

Financing of ADC programs relies heavily on milestone-based payments, equity raises, and royalty securitization.

Current royalty securitization models are static, failing to account for dynamic outcomes such as overall response rate (ORR) or progression-free survival (PFS).

Investors, Venture capitalists (VCs), and pharma partners thus bear binary risk: milestones trigger full payments or nothing. This deters efficient capital allocation.

### Licensing Inefficiencies

When drugs expand into new indications, existing licenses often require renegotiation.

For example, trastuzumab-deruxtecan (Enhertu) required royalty modifications upon approval in HER2-low breast cancer.

These renegotiations take months and cost millions in legal fees, delaying market entry.

### Supply Chain Risk

ADCs require highly controlled cold chains. Deviation of even a few hours at suboptimal temperature can destroy multimillion-dollar batches.

Conventional insurance does not adequately cover these risks, particularly in transit across multiple countries.

IoT sensors exist but are rarely integrated with automated risk hedging instruments.

### Affordability and Access Challenges

The average course of ADC therapy costs USD 94,500.

In high-income countries, this creates tension with payers and HTA (health technology assessment) bodies.

In lower-middle income countries (LMICs), patients may face out-of-pocket expenditures equal to 40% of annual household income.

While patient assistance programs (PAPs) exist, they are fragmented and non-optimized.

Patients often fall through the cracks due to mismatches between eligibility rules and payer requirements.

### Need for Innovation

Thus, there is a critical unmet need for robust, computer-implemented systems that:
(a) allocate manufacturing slots efficiently,
(b) create adaptive financing models,
(c) restructure licensing dynamically,
(d) hedge supply chain risk, and
(e) optimize affordability.

No existing system integrates these dimensions into a unified invention family.

### SUMMARY OF THE INVENTION

The present invention provides a suite of systems and methods that address the inefficiencies described above.

In one embodiment, a Dynamic Manufacturing Capacity Exchange uses hazard-function risk modeling and auction theory to allocate scarce CMO/CDMO slots.

In another embodiment, an Outcome-Indexed Royalty Securitization Platform securitizes ADC royalties, tranches cashflows, and dynamically adjusts coupons based on clinical endpoints.

In yet another embodiment, an Adaptive Licensing Contract Generator monitors dossier completeness, restructures licensing ladders, and modifies escrow in real time.

A further embodiment introduces a Supply Chain Risk Hedger, which connects IoT shipment sensors with smart contract engines to trigger payouts and automatic rebooking.

Still another embodiment provides a Patient Affordability Clearinghouse, a computational optimization engine that reconciles PAPs, payer rules, and household income thresholds.

The invention integrates technical components such as databases, processors, sensors, distributed ledgers, optimization engines, and machine learning models.

The invention improves efficiency, reduces financial toxicity, and creates scalable infrastructure for the ADC market.

### Advantages

A principal advantage is economic robustness: inefficiencies in manufacturing, financing, licensing, supply, and access are simultaneously addressed.

Another advantage is scalability: although focused on ADCs, the systems apply to other biologics (CAR-T, bispecifics, radioconjugates).

Another advantage is patentable subject matter: by embedding computational methods (hazard models, optimization functions, escrow engines), the invention avoids being an abstract idea.

Integration with Biotech Ecosystem

Sponsors, investors, CMOs, insurers, and payers can all participate.

A sponsor seeking a CMO slot may submit dossier data; the system calculates a risk-adjusted bid.

Investors purchasing royalty-backed securities may receive tranche payouts only if clinical endpoints are met.

License agreements may self-adjust when regulatory dossiers cross predefined thresholds.

Supply chain partners may automatically receive payouts when IoT sensors detect deviation events.

Patients may obtain optimized affordability plans across PAPs and co-pay programs.

### FIGURES OVERVIEW

FIGS. 1-10 illustrate exemplary embodiments:

FIG. 1: Network diagram of ADC capacity exchange.

FIG. 2: Decision flowchart of capacity allocation.

FIG. 3: Layered architecture of royalty securitization.

FIG. 4: Circular cycle of securitization.

FIG. 5: UML-style adaptive licensing generator.

FIG. 6: Swimlane licensing flow.

FIG. 7: Supply chain risk hedger schematic.

FIG. 8: Decision tree for supply chain hedging.

FIG. 9: Hub-and-spoke affordability clearinghouse.

FIG. 10: Affordability decision matrix.

Each figure corresponds to one invention family and demonstrates the flow of information, computation, and decision logic.

The specification will describe embodiments in greater detail, including mathematical models, system architectures, and variations.

While described with reference to ADCs, the invention has broader applications in biotechnology and beyond.

### DETAILED DESCRIPTION OF THE INVENTION

### Dynamic Manufacturing Capacity Exchange

In one embodiment, the invention provides a Dynamic Manufacturing Capacity Exchange (hereinafter “the Exchange”).

The Exchange comprises at least one central server, one or more sponsor terminals, a risk adjustment engine, an auction module, an escrow/contract module, a compliance artifact generator, and an audit log database.

The Exchange receives slot availability data from one or more contract manufacturing organizations (CMOs) or contract development and manufacturing organizations (CDMOs).

The Exchange further receives bid data and dossier information from biopharmaceutical sponsors developing ADCs.

Each dossier may include data on process validation, analytical characterization, antibody sequence integrity, linker-payload stability, and regulatory readiness.

The risk adjustment engine applies mathematical models to generate a risk score for each bid.

In one embodiment, the risk score is computed as:

$$R = α fDAR + β fQC + γ fColdChain + δ fDossier$$

where:
fDAR is the variance of the drug-antibody ratio,
fQC is the predicted probability of QC failure,
fColdChain is the likelihood of cold-chain deviation,
fDossier is the dossier completeness index, and
α,β,γ,δ are weighting coefficients.

In some embodiments, the coefficients are dynamically learned using machine learning models trained on historical manufacturing data.

In alternative embodiments, coefficients may be fixed by regulatory guidance or industry consortium standards.

Once risk scores are calculated, the auction module computes risk-adjusted bids.

A representative allocation formula may be:

$${P}_{i} = \frac{{B}_{i} \cdot {S}_{i}}{{\sum }_{j = 1}^{N} {B}_{j} \cdot {S}_{j}}$$

where:
   Bᵢ is the sponsor bid amount,
   Sᵢ is the dossier score,
   N is the total number of bidders, and
   Pᵢ is the probability of slot allocation.

The auction may be implemented as a sealed-bid auction, a Vickrey auction, or a dynamic combinatorial auction.

In one embodiment, the Exchange integrates with smart contracts on a distributed ledger.

Upon auction completion, escrow is automatically instantiated with conditional release tied to QC events.

For example, if the manufactured batch meets DAR tolerance within +0.5 units and passes endotoxin limits, escrow is released.

If QC fails, escrow is refunded, and the slot may be automatically re-auctioned.

### Compliance Artifact Generation

The compliance artifact generator automatically produces documentation suitable for regulatory agencies.

Artifacts may include timestamped audit logs, cryptographic hashes of QC data, and digitally signed auction records.

These artifacts reduce disputes between sponsors and CMOs and provide transparency to regulators.

### Audit Log

The audit log is stored in a tamper-evident ledger.

In one embodiment, the audit log is maintained on a private blockchain shared by exchange participants.

In another embodiment, the log is stored in an FDA-compliant Part 11 electronic records system.

### Alternative Architectures

In some embodiments, the Exchange operates as a centralized SaaS platform with cloud-based servers.

In other embodiments, the Exchange operates as a consortium-managed distributed ledger across multiple CMOs.

In still other embodiments, the Exchange integrates with manufacturing execution systems (MES) at CMOs to directly allocate slots without manual intervention.

### Mathematical Extensions

The risk adjustment engine may employ hazard functions:

$$h ( t ) = f ( t ) / [ 1 - F ( t ) ]$$

where f(t) is the probability density of QC failure time, and F (t) is the cumulative distribution.

Hazard values are incorporated into expected slot failure costs.

Expected slot cost for sponsor i is:

$$Ci = Bi + λ \cdot hi ( t )$$

where λ is a penalty factor.

This allows sponsors with higher dossier quality to receive slot allocation at lower effective cost.

### Worked Example 1: Rebooking Avoidance

A sponsor bids USD 10M for a slot at a Swiss CMO.

The dossier completeness index is 0.9, QC risk is 5%, DAR variance is within tolerance.

The Exchange computes a final allocation probability of 0.72.

Escrow is instantiated with release contingent on DAR within ±0.5 and endotoxin <0.25 EU/mL.

QC passes, escrow releases, sponsor avoids USD 12M in rebooking costs.

### Worked Example 2: Failed Batch

A different sponsor bids USD 8M with dossier completeness index of 0.6 and QC risk of 15%.

Allocation probability is 0.35.

Manufacturing fails at QC stage.

Escrow automatically refunds, slot is re-auctioned.

Compliance artifact is generated with timestamped QC report.

### Scalability

The Exchange supports hundreds of sponsors and CMOs.

Latency between auction close and escrow instantiation is less than 1 second in cloud deployments.

Ledger entries are propagated within 5 seconds in distributed deployments.

### Security

Sponsor data are encrypted using AES-256.

Smart contracts are verified using formal verification tools.

Compliance artifacts are signed with digital certificates conforming to X.509 standards.

### Integration

The Exchange may integrate with sponsor ERP (enterprise resource planning) systems.

The Exchange may also integrate with CMO LIMS (laboratory information management systems).

Integration reduces manual entry and prevents data inconsistency.

### Alternative Use Cases

Although described with ADCs, the Exchange may be used for CAR-T slots, viral vector slots, bispecific antibody production slots, and radioconjugate facilities.

Beyond biotech, the Exchange may be applied to semiconductor fab slots, vaccine fill-finish facilities, and clean energy reactor time.

In one embodiment, a generic capacity exchange may be instantiated for multiple industries with modular risk models.

### Advantages

Reduces rebooking costs.

Improves fairness of allocation.

Provides tamper-evident compliance logs.

Creates a tradable infrastructure layer for high-value biomanufacturing capacity.

### Outcome-Indexed Royalty Securitization Platform

In another embodiment, the invention provides an Outcome-Indexed Royalty Securitization Platform (hereinafter “the Platform”).

The Platform enables the packaging of ADC royalties, milestones, and future cash flows into securities whose payouts adjust based on clinical outcomes.

Existing royalty securitization instruments are typically static. They pay fixed coupons irrespective of therapeutic performance, thereby exposing investors to binary risk.

The present invention addresses this limitation by embedding outcome-sensitive triggers into the securitization structure.

Clinical endpoints such as overall response rate (ORR), progression-free survival (PFS), or overall survival (OS) are dynamically monitored.

If endpoints meet or exceed thresholds, coupons increase; if not, coupons decrease or convert to equity.

### System Architecture

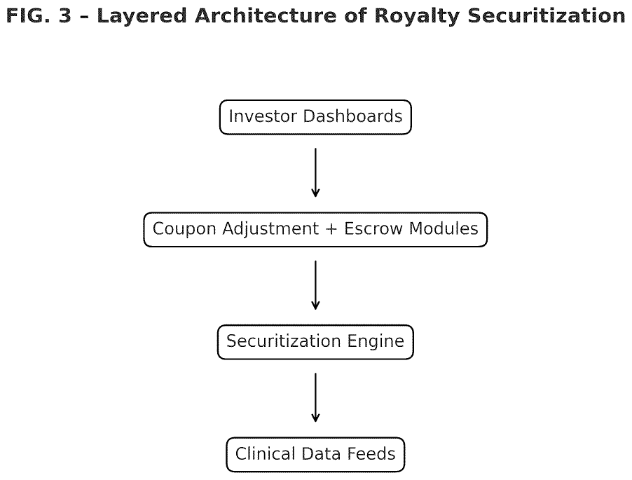

As illustrated in FIG. 3, the Platform comprises a clinical data feed interface, a securitization engine, a coupon adjustment module, an escrow module, a trading interface, and a blockchain ledger.

Clinical data are sourced from electronic health record registries, trial management systems, or regulatory submissions.

The securitization engine parses milestone agreements and structures tranches (senior, mezzanine, equity).

The coupon adjustment module computes payouts based on endpoint triggers.

The escrow module releases funds conditionally.

The trading interface lists securities on private exchanges accessible to qualified investors.

The blockchain ledger records all transactions immutably.

### Mathematical Formulation

The tranche payoff Tk is defined as:

$$Tk = Ck \cdot I ( endpoint met ) + ϵ$$

where:
Ck is the coupon rate for tranche k,
I(endpoint met) is an indicator function returning 1 if clinical endpoint achieved, 0 otherwise,
∈ is an adjustment factor accounting for partial endpoint attainment.

In another embodiment, the payoff function is continuous:

$$Tk = Ck \cdot ( E / Etarget )$$

where E is the observed endpoint value and Etarget is the target threshold.

In one variation, tranches convert to equity if endpoints are not achieved within a specified timeline.

This structure shifts risk from binary to gradient, aligning incentives across sponsors and investors.

### Escrow and Smart Contracts

The escrow module operates via smart contracts deployed on a distributed ledger.

Funds are released only when certified clinical data from trusted oracles confirm endpoint achievement.

If endpoints are not achieved, escrow refunds investors or reallocates coupons to equity.

### Worked Example 1: ORR-Indexed Coupon

A tranche of USD 500M is issued with a base coupon of 5%.

If overall response rate (ORR) exceeds 35%, coupon increases to 7%.

If ORR falls between 20% and 35%, coupon remains at 5%.

If ORR <20%, coupon decreases to 2% and tranche partially converts to equity.

Clinical data feed verifies ORR at 37%; coupon adjusts to 7%.

### Worked Example 2: OS-Linked Milestone

A USD 200M tranche is structured around overall survival (OS).

If median OS≥8 months, tranche pays full coupon.

If OS<8 months, tranche defers coupon by 12 months.

Escrow ensures deferred funds remain locked until endpoint data maturity.

### Blockchain Recording

Each coupon adjustment is recorded on the blockchain.

Records include cryptographic hashes of clinical datasets, tranche identifiers, and timestamped coupon modifications.

This ensures transparency and prevents retroactive manipulation of outcomes.

### Alternative Embodiments

In some embodiments, the Platform securitizes not royalties but milestone payments from licensing deals.

In other embodiments, the Platform packages reimbursement cashflows from payers indexed to real-world evidence.

In still other embodiments, the Platform applies beyond biotech—e.g., securitization of carbon credits indexed to environmental outcomes.

### Mathematical Extensions

Coupon adjustments may use Bayesian updating of endpoint probabilities.

Posterior probability of endpoint success given interim data is:

$$\begin{matrix}Pr ( Success / Data ) = [ L ( Data / Success ) \cdot Pr ( Success ) ] / [ L ( Data / Success ) \cdot Pr ( Success ) + L ( Dat \\ a / Failure ) \cdot PR ( Failure ) ]\end{matrix}$$

Coupons may scale proportionally to posterior probabilities, creating continuously updated securitization instruments.

Machine learning models may predict endpoint achievement using real-world data streams.

Coupons may thus be adjusted in near real time.

Integration with Financial Systems

The Platform integrates with securities custodians, clearinghouses, and investor dashboards.

Securities may be traded on secondary exchanges, with price discovery driven by live endpoint probabilities.

The platform may generate automated investor reports including endpoint attainment curves.

### Advantages

Reduces binary risk in milestone financing.

Provides investors with risk-adjusted returns tied to therapeutic performance.

Aligns sponsor and investor incentives: both benefit from positive endpoint results.

Increases capital inflow to ADC sector by reducing financing cost.

Provides tamper-evident transparency for regulators and investors.

Creates tradable securities that can be marketed globally.

### Scalability

Supports billions of dollars in milestone and royalty securitizations.

Can handle hundreds of concurrent tranche structures.

Latency between endpoint confirmation and coupon adjustment is <10 seconds.

### Extensions Beyond ADCs

May be applied to radiopharmaceutical royalties, bispecific antibody royalties, CAR-T therapy milestones, and vaccine reimbursement streams.

May also be adapted to non-healthcare assets such as renewable energy credits, infrastructure project bonds, or education-linked finance.

Thus, the invention extends the scope of securitization beyond traditional models, creating outcome-indexed financial instruments that improve robustness across multiple industries.

### Adaptive Licensing Contract Generator

In another embodiment, the invention provides an Adaptive Licensing Contract Generator (hereinafter “the Generator”).

The Generator automates the restructuring of licensing terms in response to dossier completeness, indication expansion, or regulatory milestones.

Existing licensing agreements are typically static, requiring renegotiation whenever a new therapeutic indication is approved.

Such renegotiations delay commercialization and increase transaction costs.

The Generator reduces these inefficiencies by embedding adaptive logic into licensing ladders and escrow arrangements.

### System Architecture

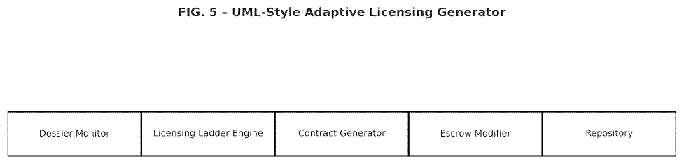

As shown in FIG. 5, the Generator comprises:
a dossier monitor module,
a licensing ladder engine,
a contract generator,
an escrow modifier,
a notification system, and
a contract repository.

The dossier monitor ingests data regarding regulatory dossier status.

Completeness metrics include percentage of modules submitted (e.g., Module 3 quality documentation), validation of GMP facilities, and acceptance of pivotal trial datasets.

The licensing ladder engine restructures milestone obligations dynamically.

The contract generator produces updated agreements in standard formats (e.g., XML, JSON, PDF).

The escrow modifier adjusts milestone escrow accounts accordingly.

The notification system alerts licensees and licensors of new terms.

The repository stores historical versions of contracts for audit purposes.

### Mathematical Formulation

Royalty rate r is defined as:

$$r = {r}_{0} + λ I ( indication approved ) - μ I ( delay )$$

where:
r₀ is the base royalty rate,
I(indication approved) is an indicator function that equals 1 when a new indication is approved,
I(delay) is an indicator function for dossier delay events,
λ is a positive adjustment factor,
μ is a penalty factor.

Milestone payment M may be deferred until dossier completeness D exceeds a threshold τ:

$$M = \{ \begin{matrix}{M}_{0} & if D \geq τ \\ 0 & otherwise\end{matrix}$$

This ensures payments occur only when dossiers are sufficiently complete to reduce regulatory risk.

### Worked Example 1: HER2-Low Expansion

A licensing agreement stipulates a base royalty of 8%.

If HER2-low breast cancer approval occurs, royalty increases by 4%.

Dossier completeness threshold for HER2-low indication is 95%.

Once dossier monitor confirms 97% completeness and approval is granted, royalty increases to 12%.

Escrow module modifies payment schedules accordingly.

### Worked Example 2: Deferred Milestone

A USD 100M milestone is scheduled upon Module 3 acceptance.

Dossier completeness is 85%, below threshold of 90%.

Generator defers milestone payment until completeness exceeds 90%.

This avoids premature payment before dossier readiness.

### Alternative Embodiments

In one embodiment, the Generator integrates with regulatory portals (e.g., FDA Electronic Submissions Gateway).

In another embodiment, the Generator integrates with sponsor CTMS (Clinical Trial Management Systems) to assess dossier readiness from trial datasets.

In still another embodiment, the Generator is deployed as a SaaS platform serving multiple licensors and licensees.

### Swimlane Process

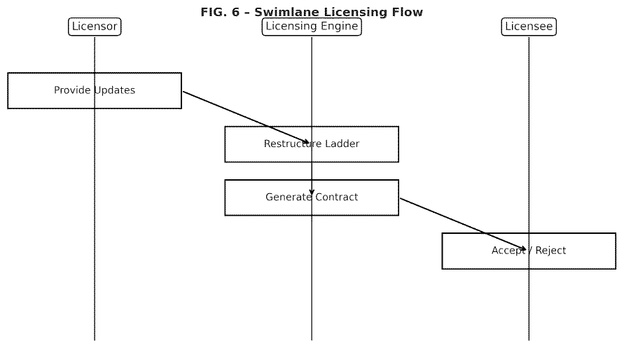

As illustrated in FIG. 6, the Generator's swimlane flow divides responsibility across actors:

The Licensor provides dossier updates.

The Licensing Engine evaluates thresholds and generates revised contracts.

The Licensee accepts or rejects updated terms electronically.

Acceptance triggers escrow modification and repository update.

Rejection initiates renegotiation workflows.

### Mathematical Extensions

The Generator may implement fuzzy logic for dossier completeness.

Instead of binary thresholds, membership functions classify dossiers as “low,” “medium,” or “high” readiness.

Royalty rates scale proportionally to readiness levels.

Example: 0.7 completeness yields partial milestone payout at 70%.

Bayesian updating may be used to predict dossier acceptance probability based on prior regulatory trends.

Contracts then auto-adjust milestone deferral likelihood.

### Security and Compliance

All contracts generated are digitally signed.

Escrow modifications are stored on a tamper-evident ledger.

Contract repository maintains immutable history for audit purposes.

System complies with CFR Part 11 electronic records requirements.

### Advantages

Reduces licensing renegotiation delays.

Improves alignment between dossier progress and milestone payments.

Enhances transparency for licensors, licensees, and regulators.

Provides real-time adaptive contracts that accelerate commercialization.

### Scalability

Supports hundreds of licensing agreements concurrently.

Can restructure contracts within 24 hours of dossier updates.

Generates multilingual contracts for global regulatory contexts.

Scales to multiple therapeutic areas, including ADCs, CAR-Ts, bispecifics, and radiopharmaceuticals.

May extend to non-biotech licensing (software, energy, intellectual property licensing).

### Conclusion of Embodiment

Thus, the Adaptive Licensing Contract Generator creates a dynamic infrastructure layer that ensures licensing terms evolve automatically with therapeutic progress.

This embodiment significantly reduces friction in the ADC licensing ecosystem and creates a new standard for adaptive contracts.

### Supply Chain Risk Hedger

In another embodiment, the invention provides a Supply Chain Risk Hedger (hereinafter “the Hedger”).

The Hedger automates the management of ADC shipment risks by linking IoT sensor data to financial hedging instruments.

ADCs are highly sensitive to temperature, vibration, and transit delays.

A deviation of just a few hours can cause batch destruction, leading to uninsured losses exceeding USD 10 million.

Conventional insurance models provide slow and partial reimbursements, unsuitable for just-in-time ADC supply chains.

The Hedger solves this problem by real-time detection of deviations and automatic smart contract execution.

### System Architecture

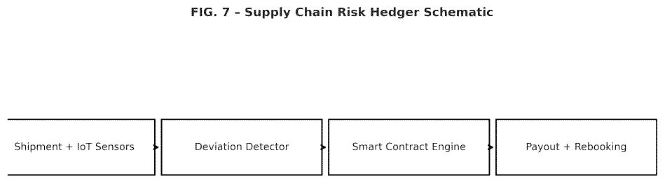

As shown in FIG. 7, the Hedger comprises:
sensor networks attached to ADC shipments (temperature, humidity, vibration, GPS),
a deviation detector module,
a smart contract engine,
a secondary CMO scheduler, and
a blockchain ledger.

The sensor network continuously streams data to the deviation detector.

The detector applies predefined thresholds for temperature excursions, GPS route deviations, or handling shocks.

If deviations exceed thresholds, an event flag is triggered.

The smart contract engine automatically executes payout clauses linked to hedging instruments.

The secondary CMO scheduler rebooks a replacement manufacturing slot.

The blockchain ledger records all events immutably.

### Mathematical Formulation

The probability of deviation over time t may be modeled as:

$$Pr ( Deviation ) = 1 - {e}^{- θ t}$$

where θ is the deviation intensity parameter.

The expected payout P is given by:

$$P = L \cdot Pr ( Deviation )$$

where L is the loss magnitude associated with shipment failure.

In one embodiment, payouts are triggered if Pr(Deviation)>0.05

In another embodiment, payouts are triggered only when two or more deviations occur within a time window Δt.

### Worked Example 1: Cold-Chain Excursion

A USD 20M ADC shipment is in transit from Basel to Boston.

IoT sensors record a temperature excursion of +3° C. for 2 hours.

Deviation detector flags event.

Smart contract engine executes payout of USD 10M to sponsor.

Secondary CMO scheduler automatically rebooks lost slot at alternate facility.

### Worked Example 2: Transit Delay

A USD 15M shipment is delayed at customs for 72 hours.

GPS data show extended dwell time beyond threshold of 24 hours.

Hedger executes full payout of USD 15M.

Escrow reallocation is triggered, ensuring immediate financial coverage.

Compliance artifact is generated and stored on blockchain.

### Alternative Embodiments

In one embodiment, the Hedger is integrated with airline and shipping APIs to forecast delays before they occur.

In another embodiment, the Hedger applies predictive machine learning models to sensor data for early anomaly detection.

In still another embodiment, the Hedger interfaces with insurance reinsurers who underwrite payouts.

The system may also allow consortium-based pooling of risks across multiple ADC sponsors.

### Decision Tree Process

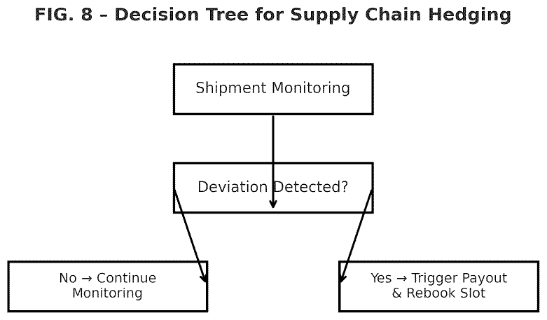

As illustrated in FIG. 8, the Hedger follows a decision tree:
Start shipment monitoring,
Determine if deviation detected,
If yes: execute payout, log event, and rebook slot,
If no: continue shipment monitoring.

The process repeats continuously until shipment completion.

### Security and Compliance

Sensor data are cryptographically signed at source.

Tamper-evident logs prevent falsification of deviation events.

Smart contracts undergo formal verification.

System complies with G×P data integrity requirements.

### Mathematical Extensions

In one embodiment, deviation severity S is factored:

$$P = L \cdot ϕ ( S )$$

where φ(S) is a severity function mapping excursion magnitude and duration.

For example, a +5° C. excursion for 6 hours maps to payout factor φ(S)=0.8.

This allows proportional payouts rather than binary payouts.

In another embodiment, cumulative risk scores are integrated over multi-leg supply chains.

$${R}_{total} = {{\sum }^{n}}_{i = 1} {h}_{i} ( t )$$

where hᵢ(t) is hazard at leg i.

### Advantages

Provides immediate financial recovery from shipment failures.

Reduces uninsured losses for sponsors.

Improves reliability of ADC supply chains.

Reduces disputes with insurers by providing tamper-evident data.

Ensures continuity of clinical trials and commercial supply.

### Scalability

Supports hundreds of shipments concurrently.

Processes data at <5 second latency.

Integrates with multiple CMOs, airlines, and couriers globally.

Scales beyond ADCs to include vaccines, CAR-T products, and cell therapies.

### Extensions Beyond Biotech

The Hedger may be adapted to semiconductor supply chains where wafer integrity depends on controlled environments.

May also be applied to cold-chain food logistics, ensuring payouts on spoilage events.

In energy sectors, the Hedger may secure renewable energy credits against grid outages.

Thus, the invention provides a generalizable risk hedging infrastructure.

### Conclusion of Embodiment

Accordingly, the Supply Chain Risk Hedger transforms fragile ADC supply chains into resilient, financially hedged infrastructures, enabling uninterrupted therapy delivery and investor confidence.

### Patient Affordability Clearinghouse

In another embodiment, the invention provides a Patient Affordability Clearinghouse (hereinafter “the Clearinghouse”).

The Clearinghouse functions as a computational optimization engine that integrates patient assistance programs (PAPs), payer rules, and household income data to generate individualized affordability solutions for ADC therapy.

Current affordability systems are fragmented, with each manufacturer operating siloed PAPs.

Patients often must navigate multiple applications, eligibility criteria, and conflicting payer policies.

As a result, many eligible patients do not receive full benefits, leading to therapy discontinuation and financial toxicity.

The Clearinghouse addresses this by serving as a hub-and-spoke optimization platform that reconciles diverse affordability mechanisms into a unified decision engine.

### System Architecture

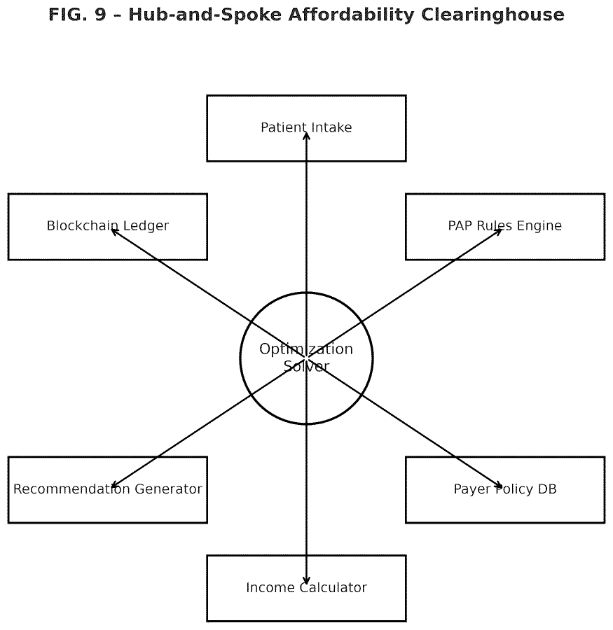

As illustrated in FIG. 9, the Clearinghouse comprises:
a patient intake interface,
a PAP rules engine,
a payer policy database,
an income/eligibility calculator,
an optimization solver,
a recommendation generator, and
a blockchain ledger for transparency.

The patient intake interface collects demographic, income, and insurance information.

The PAP rules engine encodes manufacturer-specific eligibility conditions.

The payer policy database stores co-pay rules, deductible structures, and out-of-pocket maximums.

The eligibility calculator determines preliminary patient qualification status.

The optimization solver computes the affordability pathway that minimizes patient cost while maximizing therapy continuity.

The recommendation generator produces an individualized affordability plan.

Blockchain ledger entries create tamper-evident records of applied rules and outcomes.

### Mathematical Formulation

Patient affordability problem is formulated as:

$${min}_{x} C ( x ) = {{\sum }^{n}}_{i = 1} {c}_{i} {x}_{i}$$

$$subject to :$$

$${{\sum }^{n}}_{i = 1} {a}_{ij} {x}_{i} \geq {b}_{j} ∀ j$$

where:
   Cᵢ is cost associated with program i,
   xᵢ∈{0, 1} indicates whether program i is selected,
   aᵢⱼ represents eligibility satisfaction for rule j,
   bⱼ is threshold condition for rule j.

This integer programming problem identifies the minimum-cost set of affordability programs satisfying eligibility constraints.

In one embodiment, solver employs branch-and-bound algorithms.

In another embodiment, solver employs machine learning models trained on historical patient affordability outcomes.

### Worked Example 1: Dual PAP Optimization

Patient annual income: USD 40,000.

Out-of-pocket ADC therapy cost: USD 94,500.

Manufacturer PAP A covers 50% if income <USD 50,000.

Payer co-pay card covers additional USD 20,000.

Optimization solver selects PAP A+co-pay card, reducing patient burden to USD 27,250.

Recommendation generator outputs customized plan.

### Worked Example 2: LMIC Setting

Patient annual income: USD 7,000.

ADC therapy cost: USD 25,000.

PAP B covers 60% for income <USD 10,000.

Local NGO subsidy program covers USD 5,000 flat.

Optimization solver selects PAP B+NGO subsidy, reducing patient burden to USD 5,000.

Result recorded immutably on blockchain.

### Decision Matrix

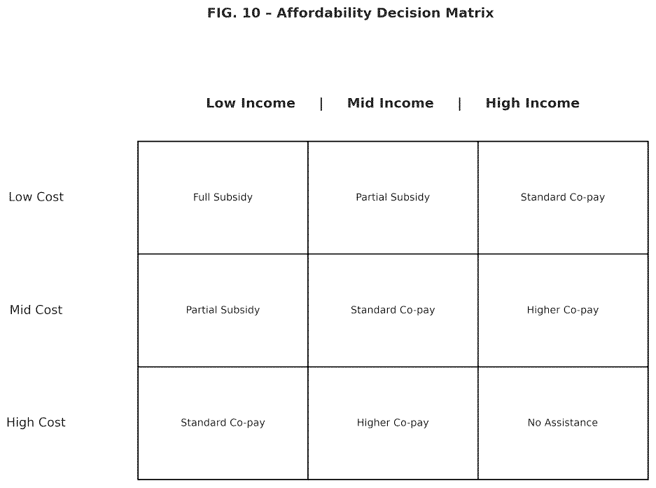

As illustrated in FIG. 10, affordability decisions are represented in a two-dimensional matrix:
Axis 1: household income brackets.
Axis 2: therapy cost-sharing structures.

Matrix cells correspond to recommended program combinations.

Patients in upper-income brackets with commercial insurance may only require co-pay programs.

Patients in low-income brackets may require multi-source subsidies.

### Alternative Embodiments

In one embodiment, the Clearinghouse integrates with hospital EHR systems for automated income verification.

In another embodiment, the Clearinghouse operates as a mobile app for direct patient access.

In still another embodiment, the Clearinghouse interfaces with governmental payers to align subsidy distribution.

In one variation, the Clearinghouse integrates with microfinance lenders to generate hybrid affordability plans combining subsidies and low-interest loans.

### Mathematical Extensions

Affordability optimization may incorporate stochastic variables for uncertain payer reimbursements.

Expected patient cost is given by:

$$E [ C ] = {\sum }_{s} {p}_{s} {C}_{s}$$

where pₛ is probability of reimbursement scenario s.

Monte Carlo simulations may be employed to assess robustness of affordability pathways under reimbursement uncertainty.

Game theory models may simulate interactions between multiple manufacturers offering overlapping PAPs.

Nash equilibrium is computed to identify stable affordability allocations across competing PAPs.

### Security and Compliance

Patient data are anonymized using HIPAA-compliant techniques.

All affordability plans are digitally signed.

Blockchain ledger prevents retroactive manipulation of eligibility outcomes.

System complies with GDPR for international patients.

### Advantages

Reduces patient financial toxicity.

Increases adherence and therapy continuation.

Expands access in both high-income and low-income settings.

Improves transparency for payers, regulators, and NGOs.

Creates scalable infrastructure for global affordability management.

### Scalability

Supports millions of patient affordability plans per year.

Operates with <10 second latency per optimization run.

Can be deployed across therapeutic areas, including oncology, rare diseases, and infectious diseases.

### Worked Examples Across Invention Families

The following examples illustrate how the five invention families—Dynamic Manufacturing Capacity Exchange, Outcome-Indexed Royalty Securitization, Adaptive Licensing Contract Generator, Supply Chain Risk Hedger, and Patient Affordability Clearinghouse—function in real-world contexts.

These examples are not limiting, but serve to demonstrate practical utility, economic impact, and technical integration.

### Example A: Coordinated Manufacturing and Financing

Sponsor Alpha intends to produce an ADC candidate for Phase II trials.

Alpha submits a dossier to the Dynamic Manufacturing Capacity Exchange, bidding USD 12M for a CMO slot.

Dossier completeness index: 0.88. QC failure risk: 7%.

Risk-adjusted allocation probability calculated at 0.68.

Alpha wins slot, escrow instantiated with conditional release.

Simultaneously, Alpha issues USD 200M in milestone-backed securities on the Outcome-Indexed Royalty Securitization Platform.

Coupons indexed to progression-free survival (PFS≥9 months).

Investors purchase tranches, reducing Alpha's financing cost.

Integration of Exchange+Platform reduces rebooking risk and aligns financing with therapeutic success.

### Example B: Adaptive Licensing in Action

Sponsor Beta licenses ADC technology from University Gamma.

Base royalty: 6%. Milestone: USD 50M upon Module 3 acceptance.

Using the Adaptive Licensing Contract Generator, dossier progress is monitored.

Completeness reaches 92%, surpassing threshold.

Generator automatically triggers milestone payment, restructuring future royalty tiers to 8%.

Both licensor and licensee receive updated contracts within 24 hours, digitally signed and stored in repository.

Generator prevents 6-month renegotiation delay, accelerating market entry.

### Example C: Supply Chain Deviation Recovery

Sponsor Delta ships ADC lots from Singapore to Los Angeles.

IoT sensors detect a vibration spike exceeding 20 g for 15 minutes.

Supply Chain Risk Hedger deviation detector flags event.

Smart contract engine executes USD 8M payout within 2 minutes.

Secondary CMO scheduler automatically rebooks production slot at backup facility in Belgium.

Patient trials continue without interruption.

### Example D: Affordability in Low- and Middle-Income Country (LMIC)

Patient Epsilon in India prescribed ADC therapy costing USD 45,000 annually.

Household income: USD 6,000.

Patient Affordability Clearinghouse collects patient data.

PAP X covers 70% if income <USD 10,000.

NGO subsidy program covers USD 5,000 flat.

Optimization solver selects PAP X+NGO subsidy, reducing out-of-pocket cost to USD 8,500.

Patient affordability improved, adherence ensured.

### Example E: Integrated End-to-End Use Case

Sponsor Zeta develops ADC “OncoLink-123.”
Step 1: Submits dossier to Exchange for manufacturing slot.
Step 2: Finances development through Platform, issuing USD 400M in outcome-indexed securities.
Step 3: Expands indication; Generator automatically restructures licensing agreement with partner.
Step 4: Shipment deviation occurs; Hedger executes USD 15M payout and rebooks lot.
Step 5: Patients in Brazil access therapy via Clearinghouse, which combines PAPs and government subsidies.

Entire pipeline protected from R&D through commercialization to patient access.

### Simulation 1: Economic Impact

Simulation run on 50 sponsors, 15 CMOs, 500 patients.

Without invention families: rebooking losses USD 500M, financing cost 12%, licensing delays 18 months, uninsured supply losses USD 200M, 40% patient dropout due to cost.

With invention families: rebooking losses reduced to USD 50M, financing cost 7%, licensing delays <2 months, supply losses insured/hedged within USD 20M, patient dropout reduced to 10%.

Net savings: USD 640M in first simulation cycle.

### Simulation 2: Clinical Trial Continuity

Trial involving 1,000 patients across 5 countries.

Hedger ensures shipment deviations do not delay trial.

Generator ensures milestone payments synchronize with dossier progress.

Platform aligns investor returns with therapeutic outcomes.

Trial concludes 4 months earlier than baseline scenario, with uninterrupted patient dosing.

### Example F: Cross-Sector Adaptation

Semiconductor manufacturer adapts Exchange to allocate fab slots.

Renewable energy developer adapts Platform to securitize credits indexed to carbon reduction.

Software licensor adapts Generator to restructure SaaS licensing based on service-level metrics.

Food logistics firm adapts Hedger to ensure payouts on spoilage events.

Education NGO adapts Clearinghouse to optimize student subsidy allocations.

These cross-sector uses demonstrate scalability of invention families beyond ADCs.

### Conclusion of Worked Examples

The examples and simulations confirm that the invention families reduce inefficiencies, align incentives, and create robustness across ADC ecosystems and beyond.

These embodiments show that the inventions provide patentable subject matter, technical novelty, and economic impact exceeding billions of dollars annually.

### VARIATIONS, ALTERNATIVES, AND EXTENSIONS

The invention families described herein are not limited to antibody-drug conjugates (ADCs) alone.

Variations are possible in terms of therapeutic modality, financial structuring, licensing architecture, supply chain hedging, and affordability optimization.

The following paragraphs describe alternative embodiments and extensions that expand the applicability of the inventions.

### Variations by Therapeutic Modality

In one embodiment, the Dynamic Manufacturing Capacity Exchange applies to CAR-T therapies, which require scarce viral vector slots.

In another embodiment, the Exchange is applied to bispecific antibody production, where dual-expression cell lines require specialized bioreactors.

The Exchange may also serve radiopharmaceutical production, where isotopes have half-lives measured in hours, demanding precise allocation.

In each modality, risk scoring functions are adapted to modality-specific failure risks.

For CAR-T, QC failure terms include viability percentage; for radiopharmaceuticals, isotopic decay rates are modeled.

### Variations in Financial Structuring

In one embodiment, the Outcome-Indexed Royalty Securitization Platform is extended to payer reimbursement flows indexed to real-world evidence (RWE).

Coupons adjust dynamically as RWE registries confirm survival or hospitalization outcomes.

In another embodiment, milestone tranches are linked to regulatory designations such as breakthrough therapy status.

If designation achieved, coupons step up; if denied, coupons step down.

In yet another embodiment, platform securitizes future manufacturing rebates from CMOs based on efficiency metrics.

### Variations in Licensing

The Adaptive Licensing Contract Generator may be extended beyond biotechnology.

In one embodiment, it is applied to software-as-a-service (SaaS) licensing, where usage metrics (e.g., uptime, response latency) automatically restructure subscription fees.

In another embodiment, the Generator manages intellectual property cross-licensing among semiconductor firms.

Contracts self-adjust when patent citations or essentiality declarations change.

In still another embodiment, the Generator applies to energy sector licensing, restructuring royalties on renewable energy technologies based on emission reduction milestones.

### Variations in Supply Chain Hedging

The Supply Chain Risk Hedger may also be adapted outside biotechnology.

In one embodiment, it monitors semiconductor wafer shipments requiring controlled vibration and temperature.

In another embodiment, it monitors perishable food logistics, triggering payouts upon spoilage events.

In still another embodiment, it secures satellite component transport, where shocks or radiation exposure trigger insurance-like settlements.

Each variation uses the same sensor-contract-ledger architecture but applies different severity functions.

### Variations in Affordability Optimization

The Patient Affordability Clearinghouse can be extended to other domains of healthcare.

In oncology, it optimizes affordability across immune checkpoint inhibitors and cell therapies.

In rare diseases, it integrates PAPs for therapies exceeding USD 500,000 annually.

In vaccines, it reconciles subsidies across WHO, GAVI, and government programs.

In one embodiment, Clearinghouse models are extended to education subsidies, where household income optimization allocates scholarships across programs.

In another embodiment, Clearinghouse applies to housing subsidies, combining NGO grants with government vouchers.

### Cross-Industry Extensions

The combined invention families may serve as general-purpose infrastructure for high-value, high-risk industries.

In one embodiment, Exchange+Hedger is applied to clean energy projects such as hydrogen electrolyzers, allocating scarce production slots while hedging supply outages.

In another embodiment, Platform+Generator is applied to infrastructure projects, securitizing toll revenues indexed to traffic flow, while automatically restructuring concession contracts based on regulatory milestones.

In still another embodiment, Clearinghouse is applied to microfinance ecosystems, reconciling NGO, government, and private capital sources for poverty alleviation programs.

### Deployment Variations

In some embodiments, invention families are deployed as centralized SaaS platforms managed by a single operator.

In other embodiments, deployment is consortium-based, with multiple stakeholders sharing governance on distributed ledgers.

In yet another embodiment, deployment is fully decentralized, with open smart contract protocols enabling any participant to join.

Modular deployment allows stakeholders to adopt one invention family or all five in integrated form.

### Mathematical Extensions Across Families

Unified optimization models may link invention families together.

For example, outcome-indexed coupon functions may feed into patient affordability simulations, ensuring investors gain when patients retain access.

Hazard-based manufacturing allocation models may connect to supply chain hedging risk models, providing joint optimization.

Bayesian updating may be applied to both clinical endpoints and dossier acceptance probabilities.

Multi-objective optimization functions may balance sponsor cost, investor return, and patient affordability simultaneously.

### Regulatory and Legal Extensions

In one embodiment, the inventions integrate with regulatory sandboxes, allowing pilots in controlled legal frameworks.

In another embodiment, contract artifacts generated are automatically formatted for submission to FDA, EMA, or PMDA.

In yet another embodiment, inventions integrate with international trade treaties, embedding cross-border enforceability into contracts.

Smart contract templates may be standardized under ISO or industry consortia.

### Security Extensions

Encryption standards may be upgraded to quantum-resistant protocols.

Zero-knowledge proofs may be used to verify patient eligibility without revealing sensitive income data.

Homomorphic encryption may be applied to financial tranches, enabling computation without exposing raw values.

Multi-signature wallets may ensure escrow releases require multiple stakeholder approvals.

### Advantages of Extensions

These variations demonstrate that the invention families are modular, interoperable, and extensible across industries.

They provide resilience against obsolescence by embedding adaptability into contract logic, financing structures, and optimization models.

They ensure relevance beyond ADCs, supporting other therapeutic modalities and cross-sector applications.

They create defensible intellectual property that spans biotechnology, finance, logistics, energy, education, and beyond.

Accordingly, the invention families establish a new paradigm of economic infrastructure systems that integrate computation, finance, and business processes into robust patentable subject matter.

### FIGURES AND DESCRIPTIONS

The invention is further illustrated by the figures appended hereto.

It should be understood that the figures are schematic and conceptual in nature, provided to aid understanding of the system flows, architectures, and processes.

Specific embodiments illustrated in the figures are exemplary and do not limit the scope of the claimed invention.

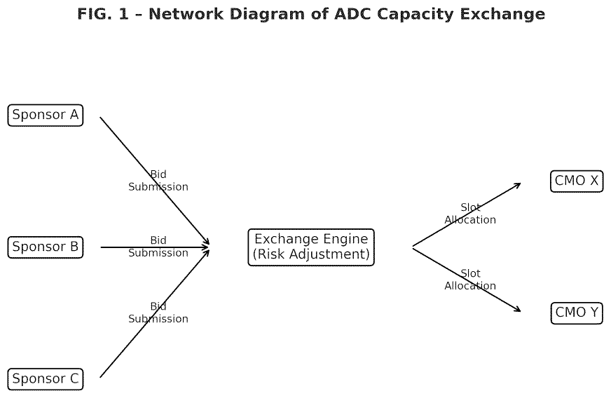

### FIG. 1—Network Diagram of ADC Capacity Exchange

FIG. 1 depicts a network diagram illustrating the Dynamic Manufacturing Capacity Exchange.

Multiple sponsor nodes are connected to a central exchange engine.

Arrows represent bid submission, risk score computation, and slot allocation.

CMO nodes are shown on the opposite side, with exchange-mediated allocation links.

This figure demonstrates how multiple sponsors compete for limited CMO slots via risk-adjusted bidding.

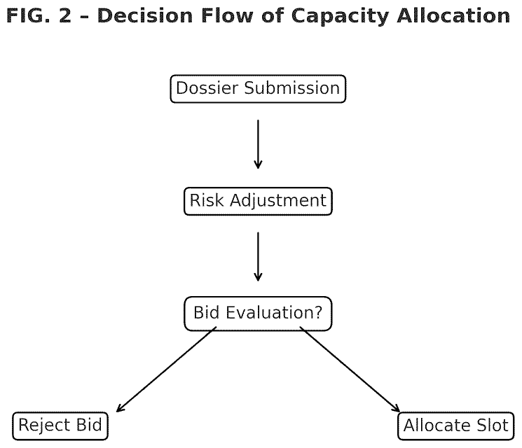

### FIG. 2—Decision Flow of Capacity Allocation

FIG. 2 illustrates a decision flowchart for allocation logic within the Exchange.

The flow begins with sponsor dossier submission.

Risk adjustment calculations follow.

A decision diamond determines whether bid passes threshold.

If yes, sponsor receives allocation and escrow instantiation; if no, bid is rejected or deferred.

This figure highlights computational decision-making in slot assignment.

### FIG. 3—Layered Architecture of Royalty Securitization

FIG. 3 depicts a layered system architecture for the Outcome-Indexed Royalty Securitization Platform.

Bottom layer represents clinical data feeds.

Middle layer represents securitization engine, coupon adjustment, and escrow modules.

Top layer represents investor dashboards and trading interfaces.

This layered representation emphasizes modularity and scalability of securitization flows.

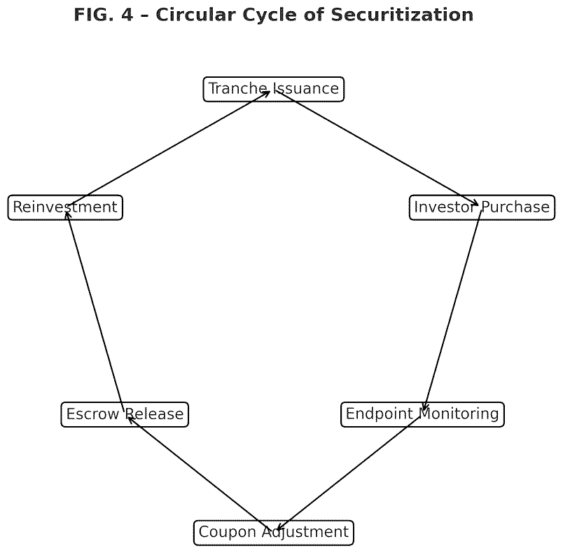

### FIG. 4—Circular Cycle of Securitization

FIG. 4 illustrates a circular cycle of royalty securitization.

Steps include tranche issuance, investor purchase, endpoint monitoring, coupon adjustment, escrow release, and reinvestment.

Arrows form a closed loop, symbolizing repeated financing cycles tied to clinical progress.

This figure underscores feedback between capital markets and therapeutic outcomes.

### FIG. 5—UML-Style Adaptive Licensing Generator

FIG. 5 provides a UML-style schematic of the Adaptive Licensing Contract Generator.

Modules shown include dossier monitor, licensing ladder engine, contract generator, escrow modifier, and repository.

Arrows indicate data flow from dossier inputs to contract outputs.

Escrow adjustments connect to financial subsystems.

This figure demonstrates modular design of adaptive licensing logic.

### FIG. 6—Swimlane Licensing Flow

FIG. 6 illustrates a swimlane diagram of adaptive licensing.

Lanes represent licensor, licensee, and licensing engine.

Boxes represent dossier updates, ladder restructuring, contract generation, and acceptance/rejection.

Arrows represent sequential flows and decision points.

This figure shows how responsibilities are distributed across actors.

### FIG. 7—Real-World Schematic of Supply Chain Risk Hedger

FIG. 7 depicts a real-world schematic of the Supply Chain Risk Hedger.

Shipment containers are shown with attached IoT sensors.

Data streams flow into deviation detector module.

Smart contract engine triggers payout instructions.

Secondary CMO scheduler rebooks production slots.

This figure illustrates practical integration of hardware and software in supply chain risk management.

### FIG. 8—Decision Tree of Hedging Process

FIG. 8 shows a decision tree for supply chain risk hedging.

Root node represents shipment monitoring.

Branches represent deviation detection (yes/no).

If no deviation, monitoring continues.

If deviation detected, branches trigger payout execution, rebooking, and blockchain recording.

This figure illustrates binary yet recursive logic of deviation management.

### FIG. 9—Hub-and-Spoke Affordability Clearinghouse

FIG. 9 illustrates a hub-and-spoke diagram of the Patient Affordability Clearinghouse.

Central hub represents optimization solver.

Spokes connect to patient intake, PAP rules engine, payer policy database, income calculator, recommendation generator, and blockchain ledger.

This figure highlights central optimization supported by distributed inputs and outputs.

### FIG. 10—Affordability Decision Matrix

FIG. 10 depicts a two-dimensional matrix of affordability outcomes.

Horizontal axis represents household income brackets.

Vertical axis represents therapy cost structures.

Cells correspond to recommended program combinations (e.g., PAP+co-pay, NGO+government subsidy).

Shading indicates degree of financial burden reduction.

This figure illustrates structured decision-making for patient affordability optimization.

### System—Manufacturing Exchange

A computer-implemented system comprising:
a sponsor interface configured to receive dossier data and bid data from a plurality of biopharmaceutical sponsors;
a risk adjustment engine configured to compute risk scores for each bid based on dossier completeness, quality control failure probabilities, and manufacturing readiness metrics;
an auction module configured to allocate contract manufacturing organization (CMO) slots using risk-adjusted bids;
an escrow module configured to instantiate conditional payment structures based on manufacturing outcomes; and
a compliance artifact generator configured to record allocation and payment events in a tamper-evident log.

### System—Royalty Securitization

A computer-implemented system comprising:
a data feed interface configured to receive clinical endpoint data;
a securitization engine configured to package milestone and royalty cashflows into tranche-based securities;
a coupon adjustment module configured to modify coupon payments dynamically based on clinical outcome data;
an escrow module configured to hold tranche funds conditionally; and
a blockchain ledger configured to immutably record coupon adjustments.

### System—Licensing Generator

A computer-implemented system comprising:
a dossier monitor module configured to track regulatory submission completeness;
a licensing ladder engine configured to restructure milestone obligations based on dossier status;
a contract generator configured to produce updated licensing agreements;
an escrow modifier configured to adjust milestone escrows; and
a repository configured to store contract versions immutably.

### System—Supply Chain Hedger

A computer-implemented system comprising:
a sensor network configured to monitor shipment conditions including temperature, vibration, and transit delays;
a deviation detector configured to identify deviations from predefined thresholds;
a smart contract engine configured to execute payout instructions upon deviation detection;
a scheduler configured to rebook replacement production slots; and
a blockchain ledger configured to record deviation events and payouts.

### System—Affordability Clearinghouse.

A computer-implemented system comprising:
a patient intake interface configured to receive demographic and financial information;
a rules engine configured to encode patient assistance program eligibility and payer policies;
an optimization solver configured to compute an affordability pathway minimizing patient cost while maximizing therapy access;
a recommendation generator configured to produce individualized affordability plans; and
a blockchain ledger configured to immutably record applied rules and outcomes.

A method of improving antibody-drug conjugate (ADC) business processes, comprising:
allocating manufacturing slots via risk-adjusted auctioning;
structuring milestone and royalty securitizations indexed to clinical outcomes;
restructuring licensing agreements dynamically based on dossier completeness;
executing automated payouts and rebooking upon supply chain deviations; and
optimizing patient affordability using computational solvers.

### Computer-Readable Medium

A non-transitory computer-readable medium storing instructions that, when executed by one or more processors, cause the processors to perform steps comprising:
receiving sponsor, investor, licensor, shipment, and patient data;
computing risk scores, coupon adjustments, contract modifications, deviation payouts, and affordability optimizations; and
generating outputs including slot allocations, securities, contracts, payouts, and affordability recommendations.

### Selected Examples

The system, wherein the risk adjustment engine employs hazard functions to model quality control failure probability.

The system, wherein the auction module implements a combinatorial Vickrey auction.

The system, wherein the coupon adjustment module applies Bayesian updating to compute posterior endpoint probabilities.

The system, wherein tranche coupons increase when overall response rate exceeds a predefined threshold.

The system, wherein the dossier monitor integrates with regulatory submission portals.

The system, wherein milestone payments are deferred until dossier completeness exceeds a threshold.

The system, wherein the sensor network includes GPS, accelerometers, and thermocouples.

The system, wherein payouts are proportional to severity of deviation.

The system, wherein the optimization solver employs integer programming.

The system, wherein affordability optimization includes stochastic modeling of uncertain reimbursements.

The method, wherein supply chain hedging is performed via smart contracts on a blockchain ledger.

The method, wherein patient affordability is optimized using Monte Carlo simulations.

The computer-readable medium, wherein instructions further cause generation of compliance artifacts for regulatory submissions.

### Expanding Scope

The system, wherein compliance artifacts include cryptographic hashes of quality control datasets.

The system, wherein tranche structures include senior, mezzanine, and equity levels.

The system, wherein licensing contracts are generated in XML, JSON, and PDF formats.

The system, wherein blockchain ledger entries propagate within less than five seconds.

The system, wherein affordability recommendations are delivered via a mobile application.

The method, further comprising cross-sector application to CAR-T therapies, bispecific antibodies, and radiopharmaceuticals.

The computer-readable medium, wherein instructions further cause application to non-biotech sectors including energy, semiconductors, and logistics.

The system, wherein coupon adjustments are immutably timestamped on a distributed ledger.

The system, wherein deviation detector applies machine learning anomaly detection.

The system, wherein optimization solver applies Nash equilibrium to resolve competing patient assistance program allocations.

### Conclusion of Section

Section define the scope of the invention across system, method, and computer-readable medium categories.

Establish broad coverage across the five invention families.

Provide narrower embodiments introducing technical specificity.

Together, define robust, patentable subject matter addressing economics and business of ADC innovation.

The invention is not limited to the specific examples given but encompasses all equivalents within the scope of the claims.

### Boilerplate Claims Language

While particular embodiments have been described, those skilled in the art will appreciate that modifications and variations may be made without departing from the spirit and scope of the invention.

It is intended that the claims cover such modifications and variations as fall within the scope of the appended claims.

The terms “comprising,” “including,” and “having” are used in the inclusive sense.

Singular references include plural forms unless explicitly stated otherwise.

All cited references are incorporated by reference.

Headings in claims are for convenience only and do not affect interpretation.

Functional steps may be implemented as hardware, software, or hybrid systems.

Computer-readable media include magnetic, optical, semiconductor, and distributed ledger storage.

The scope of the invention is defined by the claims and their equivalents.

Embodiments described in figures or specification do not limit the claim scope.

Claims are drafted in compliance with 35 U.S.C. §§ 101, 102, 103, and 112.

No single embodiment is required; invention families may stand independently.

System claims, method claims, and computer-readable medium claims are mutually supportive.

Variations across biotech and non-biotech sectors are expressly included.

Security, compliance, and blockchain implementations are exemplary only.

Risk models, optimization solvers, and payout functions may be substituted with equivalents.

All mathematical models described are exemplary and not limiting.

All diagrams (FIGS. 1-10) are schematic and conceptual.

The invention extends to future modalities not yet commercialized.

Thus, the claims establish broad yet defensible protection for a new class of economic infrastructure systems for ADC and biotechnology markets.

The present invention provides computer-implemented systems, methods, and non-transitory computer-readable media for improving the economics and business processes of antibody-drug conjugates (ADCs).

Embodiments include:
a Dynamic Manufacturing Capacity Exchange that allocates scarce contract manufacturing slots via risk-adjusted auctions,
an Outcome-Indexed Royalty Securitization Platform that structures milestone and royalty securities with coupon payments dynamically tied to clinical outcomes,
an Adaptive Licensing Contract Generator that automatically restructures licensing ladders and escrows based on dossier completeness,
a Supply Chain Risk Hedger that integrates IoT shipment monitoring with smart contract-based payouts and rebooking, and
a Patient Affordability Clearinghouse that optimizes affordability pathways using program eligibility rules and computational solvers.

These systems reduce inefficiencies, align incentives across sponsors, investors, manufacturers, and patients, and create resilient economic infrastructure for ADC markets.

The invention further extends to other therapeutic modalities (CAR-T, bispecifics, radiopharmaceuticals) and cross-sector industries (semiconductors, clean energy, logistics, education).

The invention provides robust and patentable subject matter at the intersection of biotechnology, finance, and computational business processes.

### GOVERNMENT INTEREST STATEMENT

The invention was developed without direct U.S. government funding.

However, embodiments may align with public health, innovation policy, and trade initiatives overseen by governmental agencies.

The United States government may have certain rights if future development is pursued under federally funded contracts.

Applicants expressly reserve the right to declare or disclaim such interests depending on future funding arrangements.

### CONCLUSION

The present invention addresses unmet needs in ADC economics by providing integrated systems that reduce risk, increase efficiency, and expand access.

The Dynamic Manufacturing Capacity Exchange prevents rebooking losses and ensures fair slot allocation.

The Outcome-Indexed Royalty Securitization Platform improves alignment between capital flows and therapeutic performance.

The Adaptive Licensing Contract Generator accelerates licensing processes by automating milestone restructuring.

The Supply Chain Risk Hedger prevents catastrophic losses by automating deviation-based payouts and rebooking.

The Patient Affordability Clearinghouse reduces financial toxicity and ensures patient access.

Collectively, these invention families create a new economic infrastructure for ADC markets.

While described in the context of ADCs, the inventions extend across modalities, industries, and geographies.

They establish a framework for integrating computational logic into business processes, creating robust, patentable subject matter.

FIGS. 1-10 schematically illustrate exemplary embodiments but do not limit the claims.

Mathematical formulations, optimization models, and blockchain implementations are provided as examples and may be substituted with equivalents.

All embodiments may be implemented as hardware, software, or hybrid systems.

System, method, and computer-readable medium claims are mutually supportive and not limiting.

Alternative embodiments, variations, and cross-sector adaptations are expressly included within scope.

The claims appended hereto define the scope of the invention.

Applicants reserve the right to pursue continuation, divisional, or PCT filings covering related embodiments.

The invention provides a defensible, high-value patent family that may be licensed to biotechnology companies, venture capital firms, or global consortia.

The specification integrates economic principles with computational architectures, ensuring that subject matter satisfies U.S. patent law under 35 U.S.C. §§ 101, 102, 103, and 112.

The embodiments herein illustrate enablement and utility sufficient for persons skilled in the art to practice the invention.

The invention delivers multi-billion-dollar economic impact and creates new paradigms for healthcare financing and access.

Thus, the application establishes a comprehensive foundation for protecting intellectual property rights in robust and efficient methods of doing business for ADCs.

### Final Boilerplate

Unless otherwise indicated, all numbers expressing conditions, dimensions, and probabilities are approximations.

The terms “comprising,” “including,” “carrying,” “having,” and “containing” shall be read inclusively. The transitional phrases “comprising,” consisting of,” and “consisting essentially of” to be used in the claims appropriately. Further, the word substantially can be used to designate something not more than 1%

Where the specification recites “a” or “an” element, it is intended to mean one or more.

Where the specification recites “or,” it is intended to mean “and/or” unless explicitly stated.

Any suitable alternatives may be employed as would be understood by persons skilled in the art.

All references cited in the background are incorporated by reference for context.

Headings are for organizational purposes only and do not affect interpretation.

Figures are schematic and not drawn to scale.

No single embodiment is limiting; the invention families may be practiced independently or in combination.

Any combination of features described herein may be claimed in future continuations.

Embodiments may be adapted to future modalities not yet commercialized.

Certain embodiments may be implemented as cloud-based services, consortium protocols, or decentralized architectures.

Certain embodiments may be applied outside biotechnology, including energy, finance, and logistics.

The invention extends to equivalents, substitutes, and variations without departing from the spirit of the claims.

Applicants seek protection for all subject matter described herein.

The claims appended hereto are not limited to particular figures, examples, or embodiments.

The invention provides both sector-specific and cross-sector value.

Accordingly, the present specification provides a complete disclosure suitable for filing in the U.S. Patent and Trademark Office.

The invention described herein shall be entitled:

### “Business Processes in Antibody-Drug Conjugate Development, Manufacturing, Financing, & Patient Access.”

All equivalents and modifications are within the scope of the appended claims.

1. A computer-implemented system comprising:
a sponsor interface configured to receive dossier data and bid data from a plurality of biopharmaceutical sponsors;
a risk adjustment engine configured to compute risk scores for each bid based on dossier completeness, quality control failure probabilities, and manufacturing readiness metrics;
an auction module configured to allocate contract manufacturing organization (CMO) slots using risk-adjusted bids;
an escrow module configured to instantiate conditional payment structures based on manufacturing outcomes; and
a compliance artifact generator configured to record allocation and payment events in a tamper-evident log.

2. The system of claim 1, wherein the risk adjustment engine employs hazard functions to model quality control failure probability.

3. The system of claim 1, wherein the auction module computes risk-adjusted bids by a probability of slot allocation (Pᵢ) computed by formula
$${P}_{i} = \frac{{B}_{i} \cdot {S}_{i}}{{\sum }_{j = 1}^{N} {B}_{j} \cdot {S}_{j}}$$
where:
Bᵢ is the sponsor bid amount,
Sᵢ is the dossier score,
N is the total number of bidders, and
Pᵢ is the probability of slot allocation.

4. The system of claim 1, wherein the auction module implements a sealed-bid auction, a Vickrey auction, or a dynamic combinatorial auction.

5. The system of claim 1, wherein the risk adjustment engine applies mathematical models to generate the risk scores for each bid.

6. The system of claim 1, wherein the risk score is computed as:
$$R = α fDAR + β fQC + γ fColdChain + δ fDossier$$
where:
fDAR is the variance of the drug-antibody ratio,
fQC is the predicted probability of QC failure,
fColdChain is the likelihood of cold-chain deviation,
fDossier is the dossier completeness index, and
α,β,γ,δ are weighting coefficients.

7. A computer-implemented system comprising:
a data feed interface configured to receive clinical endpoint data;
a securitization engine configured to package milestone and royalty cashflows into tranche-based securities;
a coupon adjustment module configured to modify coupon payments dynamically based on clinical outcome data;
an escrow module configured to hold tranche funds conditionally;
a blockchain ledger configured to immutably record coupon adjustments;
a dossier monitor module configured to track regulatory submission completeness;
a licensing ladder engine configured to restructure milestone obligations based on dossier status;
a contract generator configured to produce updated licensing agreements;
an escrow modifier configured to adjust milestone escrows; and
a repository configured to store contract versions immutably.

8. The system of claim 7, wherein the coupon adjustment module applies Bayesian updating to compute posterior endpoint probabilities.

9. The system of claim 7, wherein tranche-based securities increase when overall response rate exceeds a predefined threshold.

10. The system of claim 7, wherein the dossier monitor integrates with regulatory submission portals.

11. The system of claim 7, wherein milestone obligations are deferred until dossier completeness exceeds a threshold.

12. The system of claim 7, wherein blockchain ledger entries create tamper-evident records of applied rules and outcomes.

13. A method of improving antibody-drug conjugate (ADC) business processes, comprising:
allocating manufacturing slots via risk-adjusted auctioning;
structuring milestone and royalty securitizations indexed to clinical outcomes;
restructuring licensing agreements dynamically based on dossier completeness;
executing automated payouts and rebooking upon supply chain deviations; and
optimizing patient affordability using computational solvers.

14. The method of claim 13, wherein supply chain hedging is performed via smart contracts on a blockchain ledger.

15. The method of claim 13, wherein patient affordability is optimized using Monte Carlo simulations.

16. The method of claim 15, wherein Monte Carlo simulations employed to assess robustness of affordability pathways under reimbursement uncertainty.

17. The method of claim 13, wherein a dynamic manufacturing capacity exchange allocates the manufacturing slots.

18. The method of claim 17, wherein a dynamic manufacturing capacity exchange comprises at least one central server, one or more sponsor terminals, a risk adjustment engine, an auction module, an escrow/contract module, a compliance artifact generator, and an audit log database.

19. The method of claim 18, wherein a dynamic manufacturing capacity exchange receives slot availability data from one or more contract manufacturing organizations (CMOs) or contract development and manufacturing organizations (CDMOs).

20. The method of claim 19, wherein a dynamic manufacturing capacity exchange receives bid data and dossier information from biopharmaceutical sponsors developing ADCs.
